(19) United States
(12) Patent Application Publication
(10) Pub. No.: US 2011/0043743 A1
(43) Pub. Date: Feb. 24, 2011

(54) Manufacturing method of liquid crystal display device and substrate for liquid crystal display device

(75) Inventors: Takamitsu Kamada, Mobara (JP); Takanori Nakayama, Mobara (JP); Setsuo Kobayashi, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/805,836

(22) Filed: Aug. 20, 2010

(30) Foreign Application Priority Data
Aug. 20, 2009 (JP) 2009-190969

(51) Int. Cl. G02F 1/1339

(52) U.S. Cl. 349/153; 349/190

(57) ABSTRACT

A manufacturing method by which a plurality of liquid crystal cells are obtained from mother substrates includes a step of, before applying a sealing material, forming a columnar member disposed in a direction crossing a side of a second mother substrate, wherein the columnar member includes on one end side a first member disposed adjacent to an extended portion constituting a liquid crystal sealing inlet of the sealing material and at the other end a second member disposed to face at least the extended portion of the sealing material along the direction of the side, and the application of the sealing material is performed such that the extended portion of the sealing material rides on a part of the first member of the columnar member.

### CROSS-REFERENCE TO RELATED APPLICATION

The present application claims priority from Japanese application JP 2009-190969 filed on Aug. 20, 2009, the content of which is hereby incorporated by reference into this application.

### BACKGROUND OF THE INVENTION

1. Field of the Invention

The present invention relates to a manufacturing method of a liquid crystal display device and a substrate for liquid crystal display device, and particularly to a manufacturing method of a liquid crystal display device and a substrate for liquid crystal display device when a plurality of liquid crystal cells are obtained from so-called mother substrates (multi-piece substrates).

2. Description of the Related Art

In general, liquid crystal display devices are manufactured by a method in which a pair of mother substrates having a size from which a plurality of liquid crystal cells can be obtained are disposed to face each other via a sealing material which is formed so as to surround a liquid crystal sealing region of the liquid crystal cell, the gap adjustment between the pair of mother substrates is performed, and thereafter the pair of multi-piece substrates are cut to be separated into individual liquid crystal cells.

In this case, for obtaining liquid crystal cells as many as possible from a pair of mother substrates, it is desirable to form a sealing material formed in each of the liquid crystal cells close to a sealing material of an adjacent liquid crystal cell.

In this case, when the sealing material has a liquid crystal sealing inlet, and an inlet portion of the liquid crystal sealing inlet is formed of an extended portion which is formed by bending the sealing material toward one side of the liquid crystal cell, there is a disadvantage that the extended portion of the sealing material runs over into the region of the adjacent liquid crystal cell when the gap adjustment is performed by applying a load to the pair of mother substrates.

Therefore, a technique has been known in which a columnar member is formed at a boundary between the regions of adjacent liquid crystal cells, and the columnar member stops the extended portion of the sealing material from spreading into the region of the adjacent liquid crystal cell in the gap adjustment between the pair of mother substrates (refer to JP-A-2008-145634 corresponding to US Ser. No. 2008/0137024).

For example, JP-A-10-293310 (corresponding to U.S. Pat. No. 5,893,625) and JP-A-8-201825 disclose related arts of the invention. JP-A-10-293310 discloses a technique of preventing the interference by devising the pattern of the sealing material when the sealing material is formed (applied) on the substrate of each liquid crystal cell by a dispenser. JP-A-8-201825 discloses, in view of the fact that the interference of the sealing material is caused in the vicinity of the liquid crystal sealing inlet when the substrates are cut off into each liquid crystal cell, a technique of forming the liquid crystal sealing inlet after cutting off the mother substrates into each of the liquid crystal cells.

### SUMMARY OF THE INVENTION

In the technique described in JP-A-2008-145634, however, the extended portion constituting the inlet portion of the liquid crystal sealing inlet of the sealing material is formed in a state where the columnar member is separated from the extended portion before performing the gap adjustment between the mother substrates. Therefore, when the gap adjustment between the mother substrates is performed, the contact between the extended portion of the sealing material and the columnar member is rarely made in an ideal state. This is because, for example, the sealing material and the columnar member are formed independently of each other, and therefore the misalignment is generated between them in some cases. When the contact between the extended portion of the sealing material and the columnar member are made in an ideal state, the columnar member is configured as a part of the inlet portion of the liquid crystal sealing inlet. If the columnar member and the extended portion of the sealing material are not in sufficient contact with each other, there is a disadvantage that a liquid crystal leakage path is generated at the insufficient contact point.

In this case, it is conceivable to apply the technique of JP-A-10-293310 for eliminating the above-described disadvantage. In the case of JP-A-10-293310, a dot-like sealing material formed by a dispenser has a function similar to that of the columnar member. However, the dot-like sealing material itself might spread, and the generation of the liquid crystal leakage path cannot be avoided when the sealing material has a variation in position or size.

It is an object of the invention to provide a manufacturing method of a liquid crystal display device in which an extended portion constituting an inlet portion of a liquid crystal sealing inlet of a sealing material can be sufficiently prevented from running over into the region of an adjacent liquid crystal cell by a columnar member, and a reliable contact between the extended portion of the sealing material and the columnar member can be achieved, and a substrate for liquid crystal display device.

According to the manufacturing method of the liquid crystal display device of the invention, the extended portion constituting the inlet portion of the liquid crystal sealing inlet of the sealing material is formed to be in contact with the columnar member in the application of the sealing material, and the disadvantage caused by the spread of the sealing material in the gap adjustment between mother substrates is eliminated by the pattern of the columnar member.

The invention can be configured as follows, for example.

(1) A manufacturing method of a liquid crystal display device according to the invention includes: a first step of applying a sealing material on, between a first mother substrate and a second mother substrate from which a plurality of liquid crystal cells can be obtained, the second mother substrate so as to surround a liquid crystal sealing region of the liquid crystal cell, a second step of disposing the first mother substrate to face the second mother substrate and performing the gap adjustment between the second mother substrate and the first mother substrate; and a third step of cutting the first mother substrate and the second mother substrate to separate them into the plurality of liquid crystal cells, wherein the sealing material has a liquid crystal sealing inlet on the side of a first side of the liquid crystal cell where the first mother substrate and the second mother substrate are collectively cut, and the liquid crystal sealing inlet has an inlet portion formed by an extended portion of the sealing material which is bent toward the first side; wherein before the first step, a step of forming a columnar member which is disposed to cross the first side of the liquid crystal cell of the second mother substrate is included, the columnar member includes on one end side a first member disposed adjacent to the extended portion of the sealing material and at the other end a second member disposed to face at least the extended portion of the sealing material along the direction of the first side, and the application of the sealing material in the first step is performed such that the extended portion of the sealing material rides on a part of the first member of the columnar member.

(2) According to the manufacturing method of the liquid crystal display device of the invention, in (1), the extended portion of the sealing material extends in a direction in which the liquid crystal sealing inlet increases in width toward the first side, the first member of the columnar member is formed to be in contact with a side of the extended portion on the opposite side from the liquid crystal sealing inlet, and the second member of the columnar member is formed to extend in a first direction toward the center of the liquid crystal sealing inlet.

(3) According to the manufacturing method of the liquid crystal display device of the invention, in (1), the extended portion of the sealing material extends in a direction in which the liquid crystal sealing inlet increases in width toward the first side, the first member of the columnar member is formed to be in contact with a side of the extended portion on the opposite side from the liquid crystal sealing inlet, and the second member of the columnar member is formed to extend in a first direction toward the center of the liquid crystal sealing inlet and in a second direction opposite to the first direction.

(4) According to the manufacturing method of the liquid crystal display device of the invention, in (1), a columnar spacer is formed in the liquid crystal sealing region of the liquid crystal cell of the second mother substrate, and the columnar member is formed simultaneously when the columnar spacer is formed.

(5) A substrate for liquid crystal display device according to the invention includes a first mother substrate and a second mother substrate from which a plurality of liquid crystal cells can be obtained and which are disposed to face each other via a sealing material formed so as to surround a liquid crystal sealing region of the liquid crystal cell, the sealing material having a liquid crystal sealing inlet on the side of a first side of the liquid crystal cell where the first mother substrate and the second mother substrate are cut, the liquid crystal sealing inlet having an inlet portion formed by an extended portion of the sealing material which is bent toward the first side, wherein a columnar member which is disposed to cross the first side of the liquid crystal cell is formed, the columnar member including on one end side a first member disposed to abut against the extended portion of the sealing material and at the other end a second member disposed to face at least the extended portion of the sealing material outside the first side along the first side.

(6) According to the substrate for liquid crystal display device of the invention, in (5), the extended portion of the sealing material extends in a direction in which the liquid crystal sealing inlet increases in width toward the first side, the first member of the columnar member is formed to be in contact with a side of the extended portion on the opposite side from the liquid crystal sealing inlet, and the second member of the columnar member is formed to extend in a first direction toward the center of the liquid crystal sealing inlet.

(7) According to the substrate for liquid crystal display device of the invention, in (5), the extended portion of the sealing material extends in a direction in which the liquid crystal sealing inlet increases in width toward the first side, the first member of the columnar member is formed to be in contact with a side of the extended portion on the opposite side from the liquid crystal sealing inlet, and the second member of the columnar member is formed to extend in a first direction toward the center of the liquid crystal sealing inlet and in a second direction opposite to the first direction.

(8) According to the substrate for liquid crystal display device of the invention, in (5), a columnar spacer is formed in the liquid crystal sealing region of the liquid crystal cell of the second mother substrate, and the columnar member is formed of the same material as that of the columnar spacer.

The above-described configurations are illustrative only, and the invention can be modified appropriately in a range not departing from the technical idea thereof. Exemplary configurations of the invention other than the above-described configurations will be apparent from the entire description of the specification and the drawings.

Other advantages of the invention will be apparent from the entire description of the specification.

### BRIEF DESCRIPTION OF THE DRAWINGS

FIG. 1 is a configuration view of a first embodiment in a liquid crystal sealing inlet of a substrate for liquid crystal display device of the invention.

FIG. 2 is a plan view schematically showing a liquid crystal display device of the invention.

FIG. 3 is a cross-sectional view taken along line of FIG. 2.

FIG. 4 is an explanatory view schematically showing a manufacturing method of the liquid crystal display device of the invention.

FIG. 5 is an explanatory view showing that a sealing material enters the space below a columnar member.

FIG. 6 is an explanatory view showing that a part of a sealing material rides on a columnar member in the formation of the sealing material.

FIG. 7 is a configuration view corresponding to FIG. 1 where gap adjustment is not yet performed.

FIG. 8 is a configuration view of a second embodiment in a liquid crystal sealing inlet of a substrate for liquid crystal display device of the invention.

FIG. 9 is a configuration view corresponding to FIG. 1 where gap adjustment is not yet performed.

### DESCRIPTION OF THE PREFERRED EMBODIMENTS

Embodiments of the invention will be described with reference to the drawings. In the drawings and embodiments, the same reference numerals and signs are assigned to the same or similar constituents, and the description thereof is omitted.

### <Schematic Configuration of Liquid Crystal Display Device>

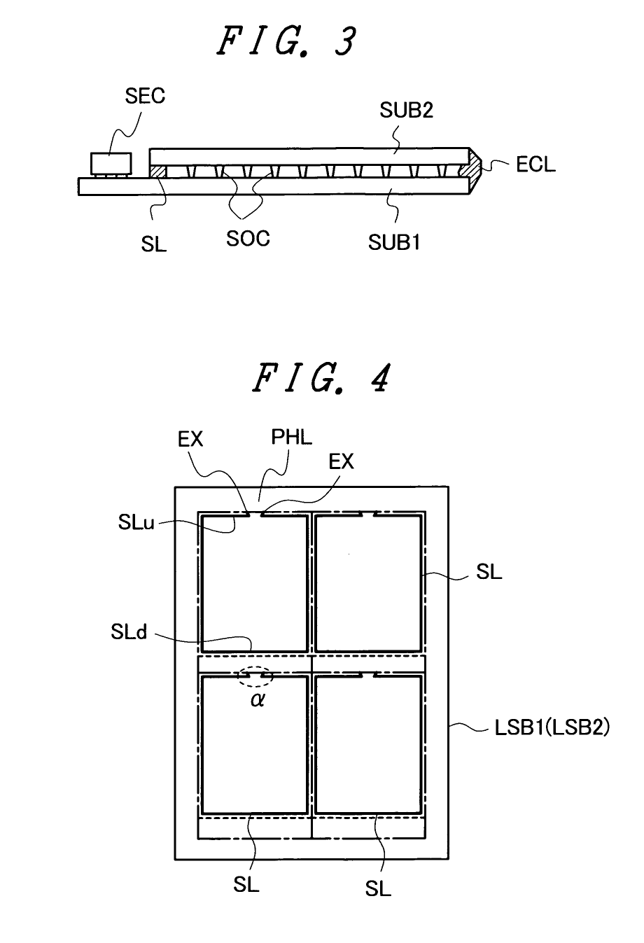

FIG. 2 is a schematic plan view showing a first embodiment of a liquid crystal display device of the invention. FIG. 3 shows a cross-sectional view taken along line of FIG. 2.

In FIG. 2, a rectangular first substrate SUB1 and a rectangular second substrate SUB2 which are disposed to face each other with liquid crystal LC (refer to FIG. 3) interposed therebetween are shown. The first substrate SUB1 is referred to as, for example, a TFT substrate. The second substrate SUB2 is referred to as a filter substrate. On a surface of the first substrate SUB1 on the liquid crystal side, signal lines, thin film transistors, pixel electrodes, and the like are formed, and on a surface of the second substrate SUB2 on the liquid crystal side, a black matrix (light shielding film), color filters, and the like are formed. In FIG. 2, however, they are not illustrated.

The second substrate SUB2 is disposed so as to expose a side portion of the first substrate SUB1 (indicated by SDd in the drawing) on the lower side in the drawing and has a slightly smaller area than that of the first substrate SUB1. A semiconductor device (chip) SEC is mounted on the side of the first substrate SUB1 on the lower side in the drawing. The semiconductor device SEC drives pixels in a later-described display region AR. Each of side wall surfaces of the first substrate SUB1 on the other sides (indicated by SD1, SDu, and SDr in the drawing) excepting the side SDd is formed to be positioned in the same plane as that of a side wall surface of the second substrate SUB2 on each of the corresponding sides. This is because, as will be apparent from a later description, the liquid crystal display device shown in FIG. 2 is one of a plurality of liquid crystal cells obtained from a pair of mother substrates which are disposed to face each other, and the sides SD1, SDu, and SDr are sides as they are when they are formed by collectively cutting the pair of mother substrates.

A sealing material SL is formed at the periphery of the second substrate SUB2 between the first substrate SUB1 and the second substrate SUB2. The sealing material SL also fixes the second substrate SUB2 to the first substrate SUB1 and seals the liquid crystal LC interposed between the first substrate SUB1 and the second substrate SUB2. In the sealing material SL, a liquid crystal sealing inlet PHL is formed on, for example, the side of the side SDu facing the side where the semiconductor device SEC is mounted. The liquid crystal sealing inlet PHL is formed as a discontinuous portion of the continuous sealing material SL. Extended portions which are formed by bending both ends of the sealing material SL formed by the discontinuity toward the side SDu constitute an inlet portion. Sealing of liquid crystal into a liquid crystal cell is performed by bring the side SDu of the liquid crystal cell into contact with the free surface of liquid crystal filled in a container under a state where the space within the sealing material SL is reduced in pressure. In this case, the inlet portion facilitates the entry of the liquid crystal into the liquid crystal cell. After completing the entry of the liquid crystal into the liquid crystal cell, the liquid crystal sealing inlet PHL is sealed by a sealant ECL. The detailed configuration of the liquid crystal sealing inlet PHL will be described later.

The region (region surrounded by the sealing material SL) into which the liquid crystal is sealed constitutes the display region AR. In the display region AR, a number of pixels (not shown) arranged in a matrix are formed. A pair of electrodes (not shown) which cause an electric field are formed in each of the pixels, and the electric field drives liquid crystal molecules in the pixel.

In this case, a plurality of columnar spacers SOC dispersed uniformly are formed in the display region AR between the first substrate SUB1 and the second substrate SUB2. The columnar spacers SOC unify the gap between the first substrate SUB1 and the second substrate SUB2 and further unify the layer thickness of the liquid crystal LC. FIG. 3 shows that the columnar spacers SOC are formed on the substrate SUB2, for example. The columnar spacers SOC are formed by selectively etching, for example, a resin layer formed on the surface of the substrate SUB2 on the liquid crystal side by a photolithography technique. Therefore, the columnar spacer SOC has an advantage that the columnar spacer can be formed at a predetermined place with a predetermined height in the display region AR.

Signal lines, thin film transistors, pixel electrodes, and the like are formed on the surface of the first substrate SUB1, which is referred to as the TFT substrate, on the liquid crystal side, and a black matrix (light shielding film), color filters, and the like are formed on the surface of the second substrate SUB2, which is referred to as the filter substrate, on the liquid crystal side. In FIG. 3, however, they are not illustrated.

<Obtaining Liquid Crystal Cell from Substrate for Liquid Crystal Display Device>

As shown in FIG. 4, the above-described liquid crystal display device (liquid crystal cell) is obtained from a substrate for liquid crystal display device including a pair of mother substrates which are disposed to face each other. For facilitating the description, FIG. 4 shows a first mother substrate LSB1 and a second mother substrate LSB2 from which, for example, four liquid crystal display devices can be taken (actually, more liquid crystal display devices can be taken). However, since the first mother substrate LSB1 is disposed so as to be stacked behind the second mother substrate LSB2, the first mother substrate LSB1 is not shown.

Regions surrounded by dashed-dotted lines in the drawing show the forming regions of four liquid crystal cells. The regions are formed adjacent to one another with no gap. The forming regions of the liquid crystal cells are formed adjacent to one another for obtaining a number of liquid crystal cells as many as possible from the first mother substrate LSB1 and the second mother substrate LSB2. As will be described later, each of the dashed-dotted lines in the drawing corresponds to a place at which the first mother substrate LSB1 and the second mother substrate LSB2 are collectively cut. Signal lines, thin film transistors, pixel electrodes, and the like are formed in each of the forming regions of the liquid crystal cells on the surface of the first mother substrate LSB1 facing the second mother substrate LSB2, and a black matrix (light shielding film), color filters, the columnar spacers, and the like are formed in each of the forming regions of the liquid crystal cells on the surface of the second mother substrate LSB2 facing the first mother substrate LSB1. In FIG. 4, however, they are not illustrated.

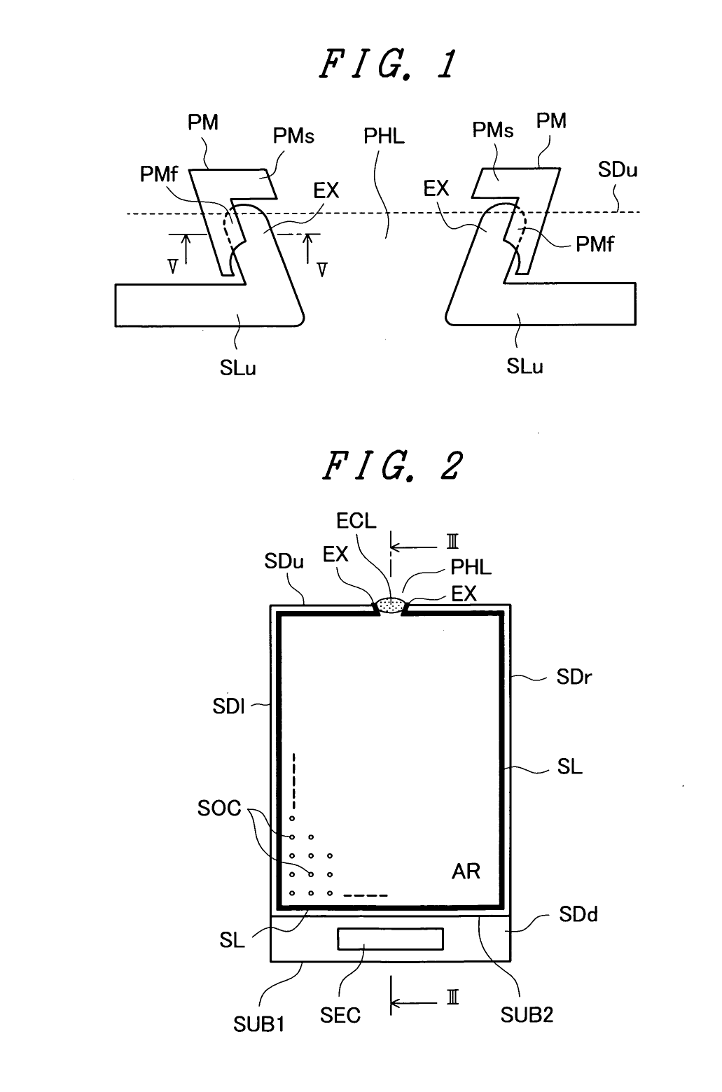

After forming the sealing material SL in each of the forming regions of the liquid crystal cells on the surface of the second mother substrate LSB2 facing the first mother substrate LSB1, the second mother substrate LSB2 is disposed to face the first mother substrate LSB1. In this case, the sealing material SL is formed (applied) on the second mother substrate LSB2 by, for example, a dispenser. In each of the liquid crystal cells, extended portions EX constituting the inlet portion of the liquid crystal sealing inlet PHL of the sealing material SL are formed so as to reach the outline (dashed-dotted line frame) of the liquid crystal cell. In this case, a front end of the extended portion EX of the sealing material SL is formed to abut against a columnar member (indicated by sign PM in FIG. 1) which is formed so as to cross the outline (dashed-dotted line frame) of the liquid crystal cell, as will be described in detail later with reference to FIG. 1, and a part of the columnar member also constitutes the inlet portion of the liquid crystal sealing inlet PHL. A sealing material SL (indicated by sign SLd in the drawing) which is formed to face the sealing material SL (indicated by sign SLu in the drawing) including the liquid crystal sealing inlet PHL is formed at a slight distance from the outline (dashed-dotted line frame) of the liquid crystal cell. This is because the region between the sealing material SLd and the outline serves as the region where the semiconductor device SEC is mounted. Thereafter, the gap adjustment between the first mother substrate LSB1 and the second mother substrate LSB2 is performed by applying a load to the first mother substrate LSB1 and the second mother substrate LSB2. The gap between the first mother substrate LSB1 and the second mother substrate LSB2 is set in accordance with the height of the columnar spacer SOC. In this case, a phenomenon is observed in which the sealing material SL is crushed and spread, and slightly increased in width.

In the thus configured substrate for liquid crystal display device, the second mother substrate LSB2 and the first mother substrate LSB1 are collectively cut along the places shown by the dashed-dotted lines in the drawing, and further, only the second mother substrate LSB2 is cut along the places shown by the dotted lines in the drawing. Therefore, individual liquid crystal cells separated from one another can be obtained. The substrate SUB1 of each of the liquid crystal cells is configured by cutting from the first mother substrate LSB1, and the substrate SUB2 is configured by cutting from the second mother substrate LSB2. In this case, the sides SD1, SDu, and SDr of the liquid crystal display device shown in FIG. 2 remain the state when the second mother substrate LSB2 and the first mother substrate LSB1 are collectively cut. Therefore, the side wall surface of the first substrate SUB1 and the side wall surface of the second substrate SUB2 on any of the sides are formed so as to be positioned in an identical plane.

Thereafter, liquid crystal is filled into the liquid crystal cell through the liquid crystal sealing inlet PHL, and the liquid crystal sealing inlet PHL is closed by the sealant ECL, whereby the liquid crystal display device shown in FIG. 2 can be obtained.

### <Detailed Configuration of Liquid Crystal Sealing Inlet>

FIG. 1 is a plan view showing in an enlarged scale the configuration of the liquid crystal sealing inlet PHL of each of the liquid crystal cells of the substrate for liquid crystal display device shown in FIG. 4 (for example, a dotted-line ellipse portion a in the drawing). FIG. 1 shows the sealing material SL and the columnar members PM newly provided in the first embodiment, which are visually recognized through the second mother substrate LSB2. FIG. 1 also shows a state after the gap adjustment between the first mother substrate LSB1 and the second mother substrate LSB2 is performed.

In the drawing, the dashed-dotted line shows the side SDu of the outline of the liquid crystal cell and corresponds to a place at which the second mother substrate LSB2 and the first mother substrate LSB1 are collectively cut. As described above, the sealing material SL (indicated by sign SLu in the drawing) is discontinued at the forming portion of the liquid crystal sealing inlet PHL. The extended portions EX which are formed by bending the both ends of the sealing material SL formed by the discontinuity toward the side SDu constitute the inlet portion. In the case of the embodiment, the pair of extended portions EX constituting the inlet portion are formed such that the distance between the extended portions are increased toward the side SDu.

In this case, the columnar member PM which is disposed to stride over (cross over) the side SDu is formed on the front end side of each of the extended portions EX. The front end of the extended portion EX is formed to abut against the columnar member PM. The formation of the columnar member PM is performed at a stage before forming (applying) the sealing material SL by using, for example, a dispenser. For example, the columnar member PM is formed simultaneously when the columnar spacer SOC is formed and formed of the same material as that of the columnar spacer SOC. This makes it possible to eliminate a disadvantage of an increase in the number of steps for manufacture due to the formation of the columnar member PM.

Each of the columnar members PM is formed into a pattern including a first member (indicated by sign PMf in the drawing) and a second member (indicated by sign PMs in the drawing). The first member PMf is formed on one end side of the columnar member PM so as to be in contact with a side of the extended portion EX of the sealing material SLu on the opposite side from the liquid crystal sealing inlet PHL. The second member PMs is formed outside the side SDu so as to face the extended portion EX of the sealing material SLu along the side SDu. With this configuration, the columnar member PM is formed into a hook-shaped pattern in which the first member PMf and the second member PMs are disposed to cross each other.

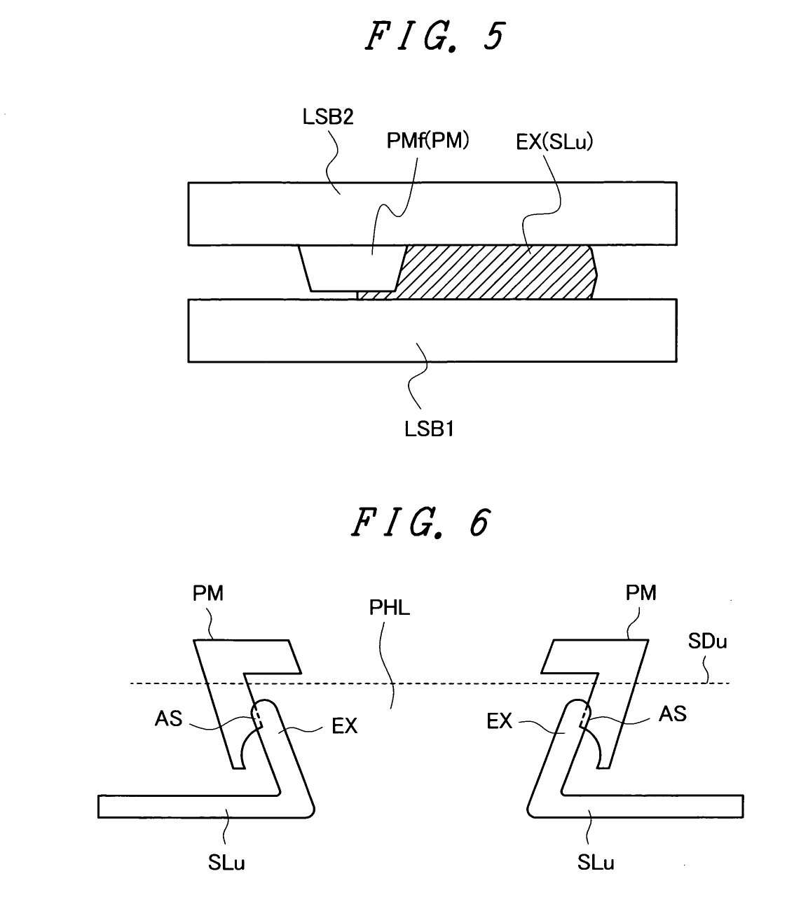

FIG. 5 shows a cross section taken along line V-V of FIG. 1. As is apparent from FIG. 5, the extended portion EX of the sealing material SLu is not only in contact with the columnar member PM (the first member PMf) but also enters the gap between the columnar member PM and the first mother substrate LSB1. This is caused by a forming method in which the sealing material SL is formed (applied) by using, for example, a dispenser on the second mother substrate LSB2 on which the columnar member PM has already been formed. Specifically, FIG. 6 is a plan view showing a state where the sealing material SL is formed on the surface of the second mother substrate LSB2 on which the columnar members PM are formed when the second mother substrate LSB2 is viewed from the surface thereof facing the first mother substrate LSB1. At the stage of forming (applying) the sealing material SL by using, for example, a dispenser, the sealing material SL is formed with a small width. This is because the gap adjustment is not yet performed by applying a load to the first mother substrate LSB1 and the second mother substrate LSB2. When forming the sealing material SL, the front end of the extended portion EX of the sealing material SL is formed so as to be in contact with the columnar member PM. This reason is as follows. If the extended portion EX is formed so as not to be in contact with the columnar member PM, the extended portion EX is often not in contact with the columnar member PM even when the sealing material SL spreads (width of the sealing material SL is increased) in the gap adjustment between the first mother substrate LSB1 and the second mother substrate LSB2. For preventing the generation of a liquid crystal leakage path at the non-contact portion, the front end of the extended portion is formed as described above. That is, with the above-described configuration, after the gap adjustment between the first mother substrate LSB1 and the second mother substrate LSB2 is performed, the reliable contact between the extended portion of the sealing material SL and the columnar member PM is achieved. In this case, as shown in FIG. 6, the front end of the extended portion EX of the sealing material SL is formed so as to ride on a part of the columnar member PM (the riding portion is indicated by sign AS in the drawing), whereby the extended portion EX can be reliably in contact with the columnar member PM.

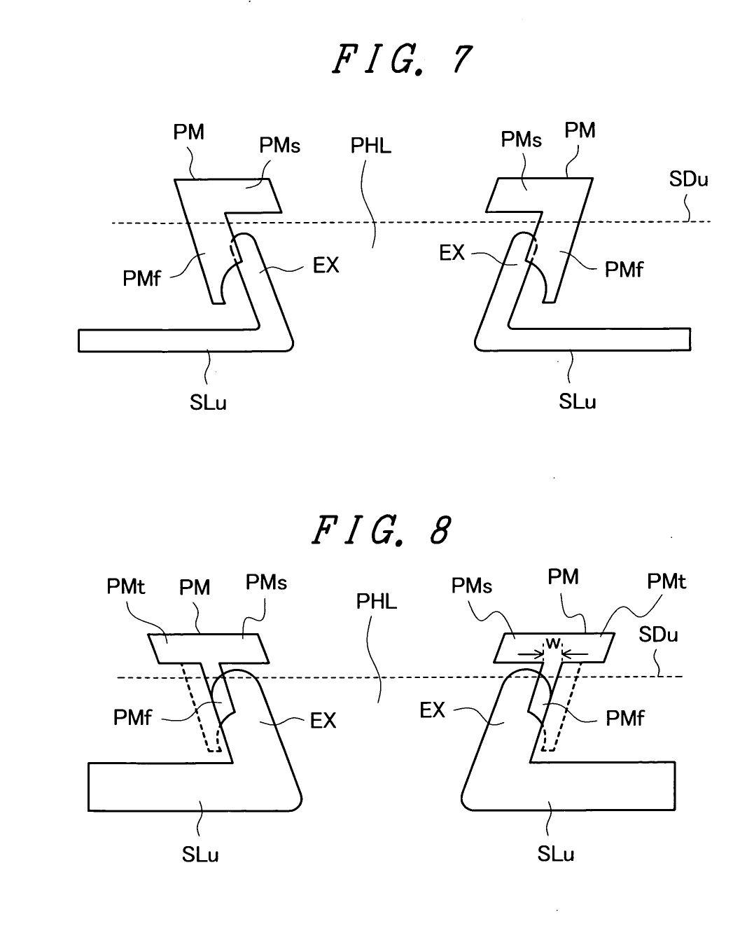

FIG. 7 is a plan view of the sealing material SL and the columnar members PM visually recognized through the second mother substrate LSB2 in a state where the first mother substrate LSB1 is disposed to face the second mother substrate LSB2 (the gap adjustment is not yet performed) in the configuration of FIG. 6. Therefore, FIG. 7 corresponds to FIG. 1, and the front end of the extended portion EX of the sealing material SL is situated below the columnar member PM and has a portion entering between the first mother substrate LSB1 and the columnar member PM.

In the state shown in FIG. 7, the gap adjustment between the first mother substrate LSB1 and the second mother substrate LSB2 is performed by applying a load to the first mother substrate LSB1 and the second mother substrate LSB2, whereby the sealing material SL spreads (width of the sealing material SL is increased), resulting in the state shown in FIG. 1. In this case, for preventing the front end of the extended portion EX from entering the region of an adjacent liquid crystal cell due to the spread of the sealing material SL, the columnar member PM is provided with the second member PMs. That is, the second member PMs has a function of stopping the entry of the sealing material SL into the region of the adjacent liquid crystal cell. As described above, by forming the extended portion EX of the sealing material SL so as to be in contact with the columnar member PM (the first member PMf), the front end of the extended portion EX is formed close to the side SDu. At the time of gap adjustment, the front end of the extended portion EX might spread to greatly cross over the side SDu. For preventing this, the columnar member PM needs to be formed into a pattern including the second member PMs.

Thereafter, the second mother substrate LSB2 and the first mother substrate LSB1 are cut to obtain liquid crystal cells. In FIG. 1, the second mother substrate LSB2 and the first mother substrate LSB1 are collectively cut at the place shown by the dashed-dotted line in the drawing. In FIG. 1, a part of the columnar member PM is formed over the forming region of the adjacent liquid crystal cell. However, the second mother substrate LSB2 at this part is to be cutoff from the adjacent liquid crystal cell, whereby also the part of the columnar member PM is to be discarded.

### Second Embodiment

FIG. 8 is a configuration view showing a second embodiment of a liquid crystal display device of the invention. FIG. 8 corresponds to FIG. 1.

The configuration of FIG. 8 is different from that of FIG. 1 in pattern of the columnar member PM. First, the first member PMf of the columnar member PM is formed with a width w smaller than that of, for example, FIG. 1 (indicated by the dotted line in the drawing). Since the first member PMf is disposed to cross the place at which the second mother substrate LSB2 and the first mother substrate LSB1 are collectively cut, this configuration intends to provide an advantage of facilitating the collective cutting by making the width w of the first member PMf smaller.

In this case, by making the width w of the first member PMf smaller, the extended portion EX of the sealing material SLu might flow to a portion of the first member PMf on the opposite side from the liquid crystal sealing inlet PHL due to its spread in the gap adjustment between the first mother substrate LSB1 and the second mother substrate LSB2, thereby entering the region of an adjacent liquid crystal cell. Therefore, the columnar member PM has a configuration in which the second member PMs is provided with a third member PMt which is extended in a direction opposite to the second member PMs at an end of the first member PMf outside the side SDu. With the third member PMt, it is possible to stop the sealing material flowing to the portion of the first member PMf on the opposite side from the liquid crystal sealing inlet PHL from entering the region of the adjacent liquid crystal cell.

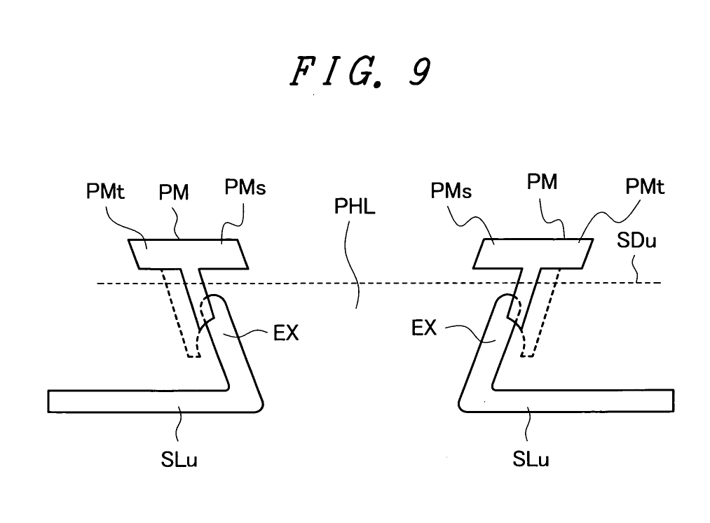

FIG. 9 shows a state where the sealing material SL is formed on the second mother substrate LSB2 and the gap adjustment between the first mother substrate LSB1 and the second mother substrate LSB2 is not yet performed in the second embodiment. FIG. 9 corresponds to FIG. 7. Also in the second embodiment, when the sealing material SL is formed, the front end of the extended portion EX of the sealing material SL is formed so as to be in contact with the columnar member PM (the first member PMf) similar to the case of FIG. 7. This is for achieving the reliable contact between the extended portion EX of the sealing material SL and the columnar member PM after the gap adjustment between the first mother substrate LSB1 and the second mother substrate LSB2 is performed, as shown in the description of the first embodiment.

### Third Embodiment

In the above-described embodiments, the columnar member PM is formed of the same material as that of the columnar spacer SOC when the columnar spacer SOC is formed. However, this is not restrictive, and the columnar member PM may be independently formed irrespective of the other materials.

While the invention has been described by using the embodiments, the configurations described in the embodiments are illustratively only. The invention can be modified appropriately within a range not departing from the technical idea thereof. The configurations described in the embodiments may be used in combination as long as they do not conflict with each other.

What is claimed is:

1. A manufacturing method of a liquid crystal display device, comprising:
a first step of applying a sealing material on, between a first mother substrate and a second mother substrate from which a plurality of liquid crystal cells can be obtained, the second mother substrate so as to surround a liquid crystal sealing region of the liquid crystal cell,
a second step of disposing the first mother substrate to face the second mother substrate and performing the gap adjustment between the second mother substrate and the first mother substrate; and
a third step of cutting the first mother substrate and the second mother substrate to separate them into the plurality of liquid crystal cells, wherein
wherein the sealing material has a liquid crystal sealing inlet on the side of a first side of the liquid crystal cell where the first mother substrate and the second mother substrate are collectively cut, and the liquid crystal sealing inlet has an inlet portion formed by an extended portion of the sealing material which is bent toward the first side;
before the first step, a step of forming a columnar member which is disposed to cross the first side of the liquid crystal cell of the second mother substrate is included,
the columnar member includes on one end side a first member disposed adjacent to the extended portion of the sealing material and at the other end a second member disposed to face at least the extended portion of the sealing material along the direction of the first side, and
the application of the sealing material in the first step is performed such that the extended portion of the sealing material rides on a part of the first member of the columnar member.

2. The manufacturing method of the liquid crystal display device according to claim 1, wherein
the extended portion of the sealing material extends in a direction in which the liquid crystal sealing inlet increases in width toward the first side,
the first member of the columnar member is formed to be in contact with a side of the extended portion on the opposite side from the liquid crystal sealing inlet, and
the second member of the columnar member is formed to extend in a first direction toward the center of the liquid crystal sealing inlet.

3. The manufacturing method of the liquid crystal display device according to claim 1, wherein
the extended portion of the sealing material extends in a direction in which the liquid crystal sealing inlet increases in width toward the first side,
the first member of the columnar member is formed to be in contact with a side of the extended portion on the opposite side from the liquid crystal sealing inlet, and
the second member of the columnar member is formed to extend in a first direction toward the center of the liquid crystal sealing inlet and in a second direction opposite to the first direction.

4. The manufacturing method of the liquid crystal display device according to claim 1, wherein
a columnar spacer is formed in the liquid crystal sealing region of the liquid crystal cell of the second mother substrate, and
the columnar member is formed simultaneously when the columnar spacer is formed.

5. A substrate for liquid crystal display device comprising a first mother substrate and a second mother substrate from which a plurality of liquid crystal cells can be obtained and which are disposed to face each other via a sealing material formed so as to surround a liquid crystal sealing region of the liquid crystal cell,
the sealing material having a liquid crystal sealing inlet on the side of a first side of the liquid crystal cell where the first mother substrate and the second mother substrate are cut, the liquid crystal sealing inlet having an inlet portion formed by an extended portion of the sealing material which is bent toward the first side, wherein
a columnar member which is disposed to cross the first side of the liquid crystal cell is formed, the columnar member including on one end side a first member disposed to abut against the extended portion of the sealing material and at the other end a second member disposed to face at least the extended portion of the sealing material outside the first side along the first side.

6. The substrate for liquid crystal display device according to claim 5, wherein
the extended portion of the sealing material extends in a direction in which the liquid crystal sealing inlet increases in width toward the first side,
the first member of the columnar member is formed to be in contact with a side of the extended portion on the opposite side from the liquid crystal sealing inlet, and
the second member of the columnar member is formed to extend in a first direction toward the center of the liquid crystal sealing inlet.

7. The substrate for liquid crystal display device according to claim 5, wherein
the extended portion of the sealing material extends in a direction in which the liquid crystal sealing inlet increases in width toward the first side,
the first member of the columnar member is formed to be in contact with a side of the extended portion on the opposite side from the liquid crystal sealing inlet, and
the second member of the columnar member is formed to extend in a first direction toward the center of the liquid crystal sealing inlet and in a second direction opposite to the first direction.

8. The substrate for liquid crystal display device according to claim 5, wherein
a columnar spacer is formed in the liquid crystal sealing region of the liquid crystal cell of the second mother substrate, and
the columnar member is formed of the same material as that of the columnar spacer.
